(19) United States
(12) Patent Application Publication
(10) Pub. No.: US 2021/0103498 A1
(43) Pub. Date: Apr. 8, 2021

(54) INFORMATION PROCESSING DEVICE, IMAGE FORMING DEVICE, AND INFORMATION PROCESSING SYSTEM

(71) Applicant: FUJI XEROX CO., LTD., Tokyo (JP)

(72) Inventors: Taku YOSHIMURA, Kanagawa (JP); Hiromi ICHIBA, Kanagawa (JP); Ryoji MATSUMURA, Kanagawa (JP); Hajime KAJIYAMA, Kanagawa (JP); Kazumoto SHINODA, Kanagawa (JP); Yu OHTAKE, Kanagawa (JP)

(73) Assignee: FUJI XEROX CO., LTD., Tokyo (JP)

(21) Appl. No.: 16/893,680

(22) Filed: Jun. 5, 2020

(30) Foreign Application Priority Data
Oct. 2, 2019 (JP) 2019-181840

(51) Int. Cl. G06F 11/14; H04N 1/00

(52) U.S. Cl. CPC G06F 11/1464; H04N 1/00084; G06F 11/1469

(57) ABSTRACT

An information processing device is connected to an image forming device via a network, and includes a processor configured to, in a case where backup processing or restoration processing for setting information of the image forming device is executed by way of a remote operation, associate and register device information that uniquely specifies the image forming device, and identification information for a remote operation service in which the backup processing or the restoration processing is executed by way of a remote operation, in a case where the device information and the identification information are acquired from the image forming device without the image forming device being operated remotely, prior to the backup processing or the restoration processing.

### CROSS-REFERENCE TO RELATED APPLICATIONS

This application is based on and claims priority under 35 USC 119 from Japanese Patent Application No. 2019-181840 filed Oct. 2, 2019.

### BACKGROUND

### (i) Technical Field

The present disclosure relates to an information processing device, an image forming device, and an information processing system.

### (ii) Related Art

When the setting information of a multifunction device is to be backed up and restored, it is sometimes the case that a customer engineer backs up and restores the setting information of the target multifunction device by way of a remote operation without directly operating the multifunction device.

### SUMMARY

When backing up and restoring the setting information of a multifunction device by way of a remote operation as mentioned above, there is a possibility that backup and restoration may be carried out for an unintended multifunction device.

Aspects of non-limiting embodiments of the present disclosure relate to ensuring that backup processing or restoration processing is carried out for the intended image forming device in a case where backup processing or restoration processing for the setting information of an image forming device is to be carried out by way of a remote operation.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing device connected to an image forming device via a network, and including a processor configured to, in a case where backup processing or restoration processing for setting information of the image forming device is executed by way of a remote operation, associate and register device information that uniquely specifies the image forming device, and identification information for a remote operation service in which the backup processing or the restoration processing is executed by way of a remote operation, in a case where the device information and the identification information are acquired from the image forming device without the image forming device being operated remotely, prior to the backup processing or the restoration processing.

### BRIEF DESCRIPTION OF THE DRAWINGS

An exemplary embodiment of the present disclosure will be described in detail based on the following figures, wherein:

FIG. 1 is an overall schematic view of a backup/restoration system in an exemplary embodiment of the present disclosure;

FIG. 2A is a drawing depicting a hardware configuration of a cloud server, and FIG. 2B is a functional block diagram of the cloud server;

FIG. 3 is a drawing depicting a list of registration information stored in the cloud server;

FIG. 4A is a drawing depicting a hardware configuration of a multifunction device, and FIG. 4B is a functional block diagram of the multifunction device;

FIG. 5 is a flowchart depicting the flow of device registration processing in the multifunction device;

FIGS. 6A to 6D are an example of a series of user interfaces displayed on a user interface device of the multifunction device when the device registration processing of FIG. 5 is carried out;

FIGS. 7A to 7C are an example of a series of images displayed on the user interface device of the multifunction device in continuation from FIGS. 6A to 6D;

FIG. 8 is a flowchart depicting the flow of device registration processing in the cloud server;

FIG. 9 is a flowchart depicting the flow of processing to back up setting information of the multifunction device;

FIGS. 10A to 10C are an example of a series of user interfaces displayed on a display device of a remote operation terminal when the backup processing of FIG. 9 is carried out;

FIG. 11 is a flowchart depicting the flow of processing to restore setting information to the multifunction device from the cloud server; and

FIGS. 12A to 12E are an example of a series of user interfaces displayed on the display device of the remote operation terminal when the restoration processing of FIG. 11 is carried out.

### DETAILED DESCRIPTION

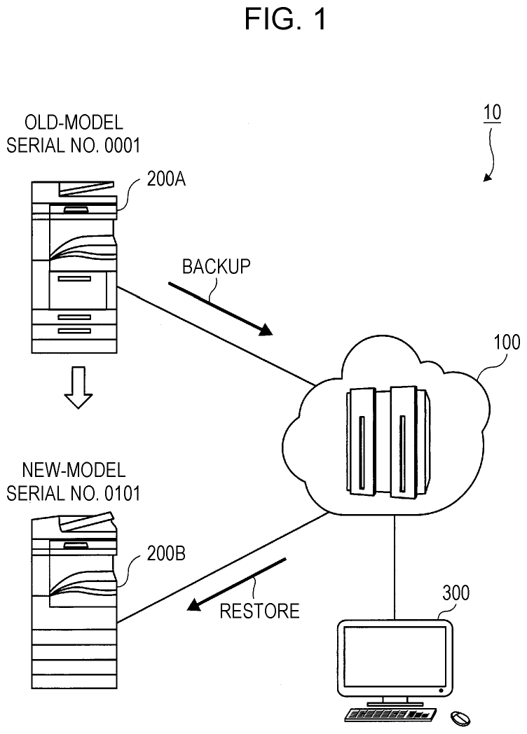

A backup/restoration system 10 in an exemplary embodiment of the present disclosure will be described with reference to FIG. 1. It should be noted that FIG. 1 is an overall schematic view of the backup/restoration system 10 in an exemplary embodiment of the present disclosure. The backup/restoration system 10 is provided with a cloud server 100, multifunction devices 200A and 200B connected to the cloud server 100 via a network, and a remote operation terminal 300 connected to the cloud server 100 also via the network.

In this backup/restoration system 10, the multifunction device 200A is an old model whereas the multifunction device 200B is a new model. In various offices where multifunction devices are installed, it becomes necessary for an old-model multifunction device 200A to be replaced with a new-model multifunction device 200B. In such cases, if the setting information of the old-model multifunction device 200A is temporarily backed up to the cloud server 100 and the setting information backed up to the cloud server 100 is restored in the new-model multifunction device 200B, it is no longer necessary for settings to be implemented again from the beginning in the new-model multifunction device 200B. It should be noted that, in the description given hereinafter, the old-model multifunction device 200A and the new-model multifunction device 200B are referred to simply as the multifunction devices 200 when described collectively. Furthermore, the serial number “0001” is set for the old-model multifunction device 200A and the serial number “0101” is set for the new-model multifunction device 200B.

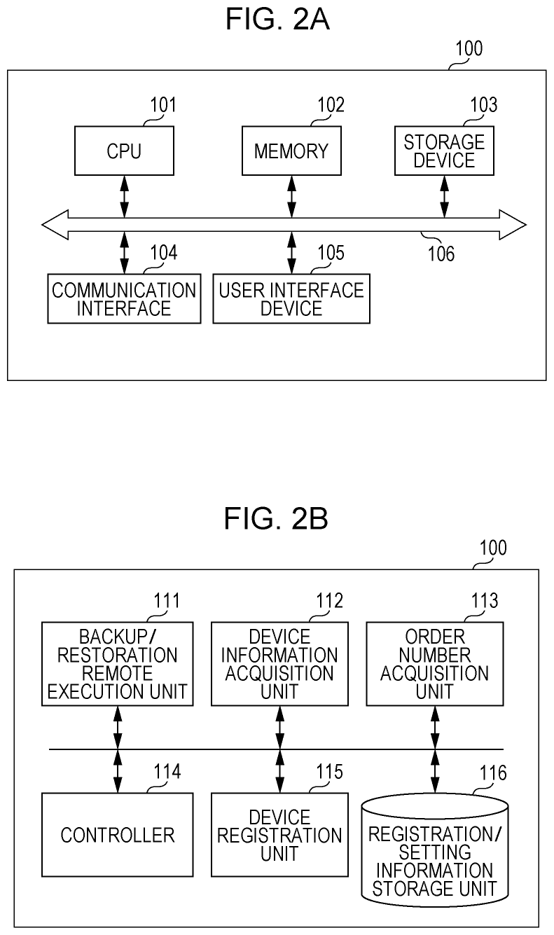

Next, the cloud server 100 will be described with reference to FIG. 2. The description given hereinafter relates to an example where the cloud server 100 serves as an information processing device that backs up/restores the setting information of a multifunction device 200; however, it should be noted that the present disclosure is not restricted to the cloud server 100 and a physical server may be used. It should be noted that FIG. 2A is a drawing depicting a hardware configuration of the cloud server 100, and FIG. 2B is a functional block diagram of the cloud server 100. As depicted in FIG. 2A, the cloud server 100 has a CPU 101, a memory 102, a storage device 103, a communication interface 104, and a user interface device 105, each of which is connected to a control bus 106.

The CPU 101 is a virtual central processing unit or a virtual processor of the cloud server 100, and controls the operation of each unit of the cloud server 100 on the basis of a control program stored in the storage device 103.

The memory 102 has temporarily stored therein registration information and setting information acquired from the storage device 103, and device information and setting information acquired from the multifunction devices 200.

The storage device 103 is constituted by a hard disk drive (abbreviated as HDD) or a solid-state drive (abbreviated as SSD), and a control program for controlling each unit of the cloud server 100 is stored therein. Furthermore, registration information and setting information that is backed up from the multifunction devices 200 is stored in the storage device 103.

The communication interface 104 carries out communication between the cloud server 100 and the multifunction devices 200 and remote operation terminal 300, and carries out communication control for acquiring and transmitting device information and setting information.

The user interface device 105 is constituted by a liquid crystal display and a keyboard connected to the cloud server 100.

As depicted in FIG. 2B, the cloud server 100 is configured to perform the functions of a backup/restoration remote execution unit 111, a device information acquisition unit 112, an order number acquisition unit 113, a controller 114, a device registration unit 115, and a registration/setting information storage unit 116 by the control program stored in the storage device 103 being executed in the CPU 101.

The backup/restoration remote execution unit 111 backs up setting information of the multifunction devices 200, and restores the setting information stored in the registration/setting information storage unit 116 to the multifunction devices 200, in accordance with instructions input via the remote operation terminal 300.

The device information acquisition unit 112 acquires device information from the multifunction devices 200. Specifically, when there is a device registration request from a multifunction device 200, the device information acquisition unit 112 acquires the serial number of the multifunction device 200.

The order number acquisition unit 113 acquires order numbers input by customer engineers from the multifunction devices 200 and the remote operation terminal 300. Specifically, an order number that is input from a multifunction device 200 or the remote operation terminal 300 is acquired when there is a device registration request from a multifunction device 200 or prior to backup/restoration work according to an instruction from the remote operation terminal 300.

The controller 114, for example, issues instructions to transmit the success or failure of the registration of a multifunction device 200 to the multifunction device 200 in question, acquires necessary information from the registration/setting information storage unit 116, and generates various types of web interfaces on the basis of acquired information and provides the web interfaces to the remote operation terminal 300.

In a case where backup processing or restoration processing of the setting information of a multifunction device 200 is executed by way of a remote operation, the device registration unit 115 carries out registration by associating and storing an order number and device information of the multifunction device 200 in the registration/setting information storage unit 116 in a case where the order number and the device information are acquired from the multifunction device 200 without the multifunction device 200 being operated remotely, prior to the backup processing or the restoration processing. Specifically, when there is a device registration request directly from a multifunction device 200, device information and an order number acquired from the multifunction device 200 are associated and stored in the registration/setting information storage unit 116.

The device registration unit 115 may be provided with a function to determine whether or not the device information of a multifunction device 200 and an order number have been transmitted by the multifunction device 200 being operated directly, and may be configured to permit the acquisition of device information and an order number from a multifunction device 200 only in a case where device information of a multifunction device 200 and an order number have been transmitted by the multifunction device 200 being operated directly, and to prohibit device information of a multifunction device 200 and an order number being acquired from the multifunction device 200 and associated by way of a remote operation carried out by the remote operation terminal 300. In addition, when an order number is designated from the remote operation terminal 300, the device registration unit 115 acquires device information of the multifunction device 200 associated with the order number from the registration/setting information storage unit 116, and outputs the device information to the remote operation terminal 300.

The registration/setting information storage unit 116 stores: registration information in which the device information of a multifunction device 200 and an order number are associated and stored; and setting information backed up from the multifunction devices 200.

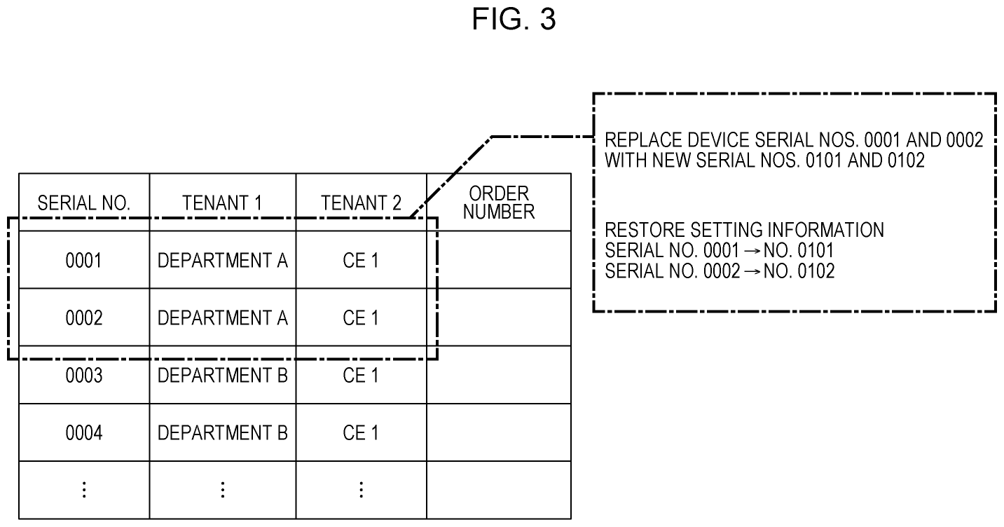

FIG. 3 is a drawing depicting a list of registration information stored in the cloud server 100. In the registration information stored in the registration/setting information storage unit 116 of the cloud server 100, a device serial number, a tenant 1, a tenant 2, and an order number are associated and stored, as depicted in FIG. 3.

Here, the device serial number is device information that uniquely specifies a multifunction device 200. Furthermore, a tenant is an organization or a group of users authorized to operate multifunction devices 200, and, for example, includes a department of a company, a single office, and customer engineers responsible for the management and proxy operation of multifunction devices 200 installed therein. It is possible for multiple tenants, two for example, to be set for each multifunction device 200. Furthermore, an order number is identification information for distinguishing between remote operation services in which backup processing or restoration processing is executed by way of a remote operation.

As depicted in FIG. 3, for example, “Department A” and “CE 1” are respectively associated as tenant 1 and tenant 2 with a multifunction device 200 having the serial number “0001”, and an order number is not yet associated therewith. That is, users of “Department A” and the customer engineer “CE1” are able to use or are authorized to operate the multifunction device 200 having the serial number “0001”, namely the old-model multifunction device 200A of FIG. 1. Although described later, when a device registration request is received together with an order number and a serial number from the multifunction device 200 having the serial number “0001”, the order number is registered in the order number column and associated with the serial number.

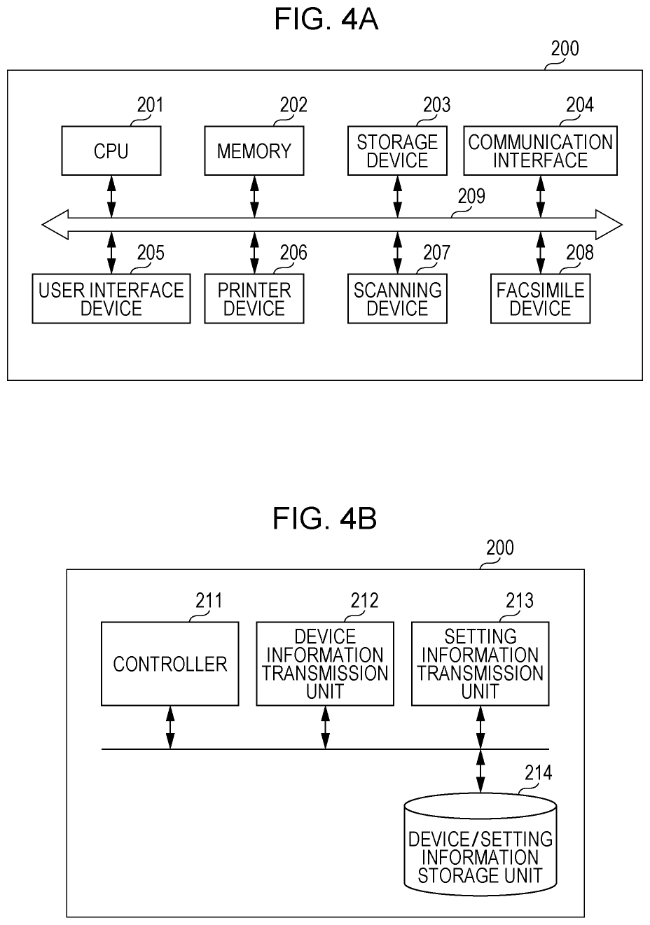

Next, the multifunction devices 200A and 200B of the present exemplary embodiment will be described with reference to FIG. 4. It should be noted that, in the present exemplary embodiment, although the multifunction device 200A is an old model in contrast with the multifunction device 200B which is a new model, the functions thereof for backup/restoration processing are the same, and therefore, in the description given hereinafter, the multifunction devices will be referred to as the multifunction device 200 when not distinguishing therebetween, and configurations and functions common to both multifunction devices will be denoted by the same reference numerals. It should be noted that FIG. 4A is a drawing depicting a hardware configuration of the multifunction device 200, and FIG. 4B is a functional block diagram of the multifunction device 200.

The multifunction device 200 has a CPU 201, a memory 202, a storage device 203, a communication interface 204, a user interface device 205, a printer device 206, a scanning device 207, and a facsimile device 208, each of which is connected to a control bus 209.

The CPU 201 is a control microprocessor and controls the operation of each unit of the multifunction device 200 on the basis of a control program stored in the storage device 203.

The memory 202 temporarily stores image data to be printed by the multifunction device 200, scanned image data, and order numbers input by customer engineers.

The storage device 203 is constituted by a hard disk drive (abbreviated as HDD) or a solid-state drive (abbreviated as SSD), and a control program for controlling each unit of the multifunction device 200 is stored therein. Furthermore, setting information and device information of the multifunction device 200 is stored in the storage device 203. Here, it should be noted that the device information includes device-specific information such as a device serial number, which is information that uniquely specifies the multifunction device 200. Product information such as the product name and model information of the multifunction device 200 may be included in the storage device 203 in addition to the device information.

The communication interface 204 carries out communication between the multifunction device 200 and the cloud server 100 and remote operation terminal 300, and carries out communication control for transmitting device information and setting information.

The user interface device 205 is constituted by a liquid crystal display and a touch panel provided in the multifunction device 200 and displays various types of screens such as those described hereinafter on the liquid crystal display, and is able to receive operations and input information by a user or customer engineer operating the touch panel.

The printer device 206 prints, onto paper, images transmitted from an undepicted computer terminal connected to the multifunction device 200 via the network. The scanning device 207 reads in image data from a document placed on a document holder, stores the image data in the memory 202, and transmits the image data to an undepicted computer terminal connected to the multifunction device 200 via the network. The facsimile device 208 transmits, to another multifunction device or facsimile device via a telephone line, image data read in by the scanning device 207 and stored in the memory 202, or image data transmitted from a computer terminal and stored in the memory 202. It should be noted that detailed descriptions are omitted in the present exemplary embodiment for the printer device 206, the scanning device 207, and the facsimile device 208.

As depicted in FIG. 4B, the multifunction device 200 is configured to perform the functions of a controller 211, a device information transmission unit 212, a setting information transmission unit 213, and a device/setting information storage unit 214, by the control program stored in the storage device 203 being executed in the CPU 201.

The controller 211, for example, generates various types of screens described later and causes these to be displayed on the user interface device 205, authenticates information that is input when a customer engineer logs in to operate the multifunction device 200, and receives backup processing requests and restoration processing requests from the cloud server 100 and executes processing corresponding thereto.

The device information transmission unit 212 acquires the serial number of the multifunction device 200 stored in the device/setting information storage unit 214 and transmits the serial number to the cloud server 100 or permits transmission processing, only when an order number is input directly from the user interface device 205 of the multifunction device 200 by a customer engineer. That is, in a case where backup processing or restoration processing for the setting information of the multifunction device 200 is executed by receiving a remote operation, the device information transmission unit 212 prohibits transmission processing for device information so that the device information of the multifunction device 200 is not transmitted by way of a remote operation, apart from when an order number is input directly from the user interface device 205 of the multifunction device 200, prior to the backup processing or the restoration processing.

In a case where a backup processing request is received from the cloud server 100, the setting information transmission unit 213 acquires the setting information of the multifunction device 200 saved in the device/setting information storage unit 214 and transmits the setting information to the cloud server 100.

The device/setting information storage unit 214 stores device information, setting information, and device administrator information of the multifunction device 200. It should be noted that the device information includes device-specific information such as a serial number that uniquely specifies the multifunction device 200. The device/setting information storage unit 214 may additionally store product information such as the product name and model information of the multifunction device 200. The setting information includes function settings of the multifunction device 200 such as common settings, copy settings, printer settings, network settings, scanner settings, facsimile settings, saved document settings, security settings, user settings, a destination table, job flow settings, and confidential box settings. The device administrator information is information regarding IDs and passwords of device administrators and customer engineers who are authorized to operate the multifunction device 200.

The remote operation terminal 300 is a personal computer or a tablet computer terminal connected to the cloud server 100 via the network, and is provided with a memory and a control processor that controls the operation of each unit, and a user interface device including a display device such as a liquid crystal display and input devices such as a keyboard and mouse or a touch panel. This remote operation terminal 300 functions as a user interface for the cloud server 100, displaying a web user interface provided by the cloud server 100 and carrying out input operations, and therefore a detailed description thereof is omitted.

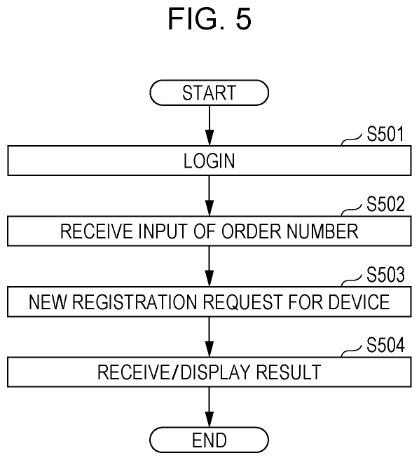

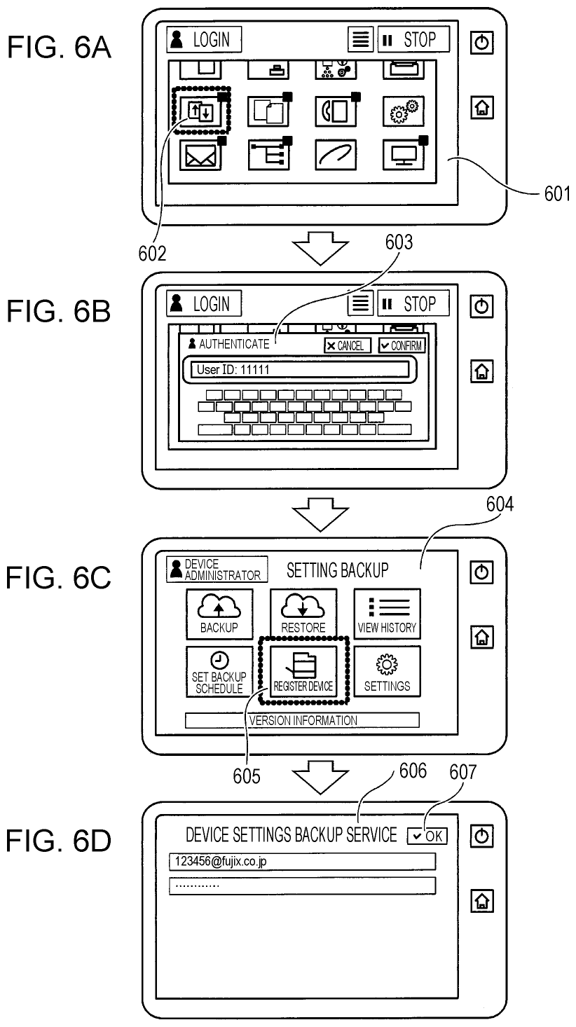

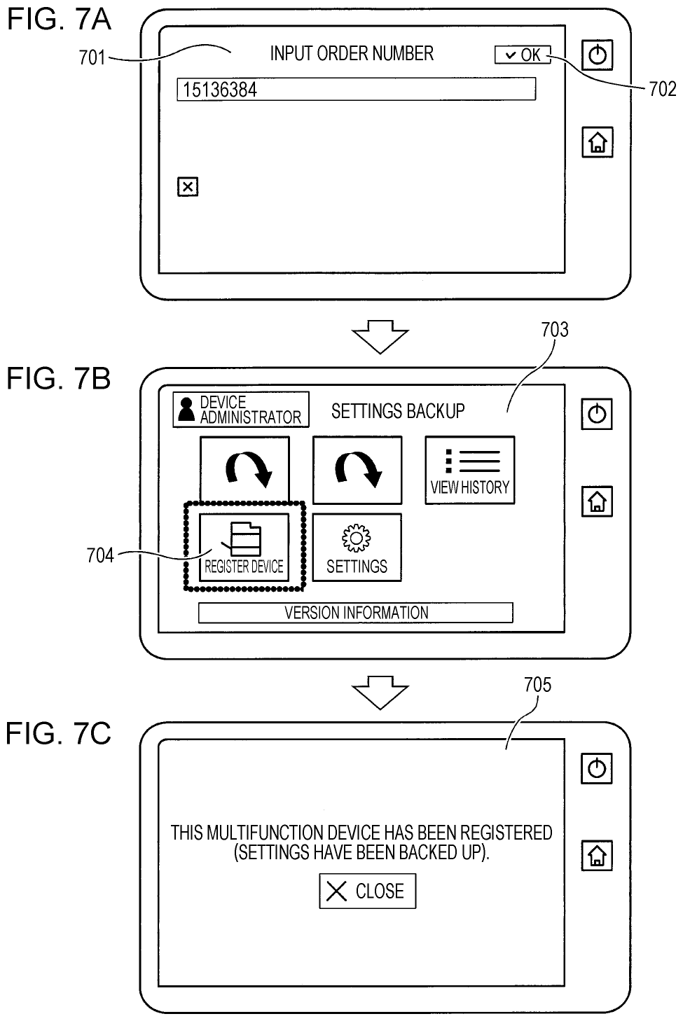

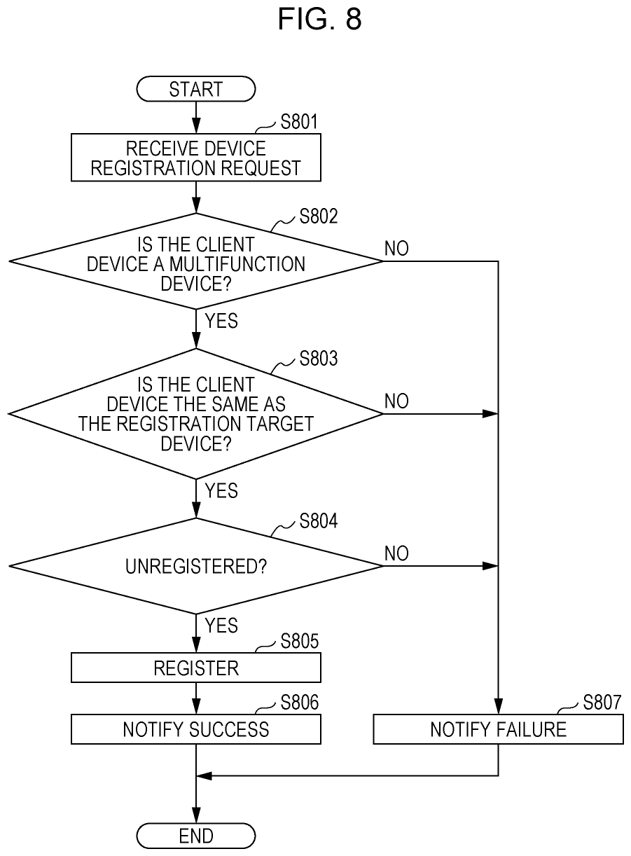

Next, the flow of device registration processing of the multifunction device 200 will be described with reference to FIGS. 5 to 8. It should be noted that FIG. 5 is a flowchart depicting the flow of device registration processing in the multifunction device 200, FIGS. 6A to 6D are an example of a series of user interfaces displayed on the user interface device 105 of the multifunction device 200 when the device registration processing of FIG. 5 is carried out, and FIGS. 7A to 7C are an example of a series of images displayed on the user interface device 105 of the multifunction device 200 in continuation from FIGS. 6A to 6D. In addition, FIG. 8 is a flowchart depicting the flow of device registration processing in the cloud server 100.

It should be noted that the cloud server 100 issues an order number prior to the backup/restoration processing, and this order number is associated in advance with a customer engineer who carries out this registration processing, namely a tenant.

First, in step S501, the customer engineer logs in to the multifunction device 200 by operating the user interface device 205 of the multifunction device 200. Specifically, the controller 211 of the multifunction device 200 displays a menu screen 601 such as that depicted in FIG. 6A on the user interface device 205. When the customer engineer selects the “Setting Backup” icon 602 in the menu screen 601, the controller 211 displays a device administrator information input screen 603 depicted in FIG. 6B. When the customer engineer inputs device administrator information by operating the user interface device 205, the controller 211 carries out a comparison with device administrator information stored in the device/setting information storage unit 214, and if there is a match, the login is deemed to be successful, processing proceeds to step S502 of FIG. 5, and a setting backup menu screen 604 depicted in FIG. 6C is displayed.

In step S502, the controller 211 waits to receive input of an order number via the user interface device 205. Specifically, first, as depicted in FIG. 6C, when the customer engineer selects the “Register Device” icon 605 in the setting backup menu screen 604, the controller 211 displays a confirmation screen 606 depicted in FIG. 6D. Device administrator information of the customer engineer, namely tenant information of the customer engineer including a registered ID and password, is displayed on the confirmation screen 606.

In the confirmation screen 606 in FIG. 6D, when the customer engineer confirms the displayed device administrator information and presses an “OK” button 607 to give approval, the controller 211 causes the user interface device 205 to display an order number input screen 701 depicted in FIG. 7A. The customer engineer inputs an eight-digit order number by operating the user interface device 205 and presses an “OK” button 702. It should be noted that, at such time, when an erroneous order number or a numeral that does not satisfy the number of digits is input, it is ensured that a previously input order number or the like is not acquired from the memory 202 and displayed.

When an order number is input by the customer engineer, processing proceeds to step S503 of FIG. 5. In step S503, the controller 211 displays a setting backup menu screen 703 such as that depicted in FIG. 7B on the user interface device 205. It should be noted that the setting backup menu screen 703 of FIG. 7B has less displayed items compared to the setting backup menu screen 604 of FIG. 6C. When the customer engineer selects the “Register Device” icon 704 of the setting backup menu screen 703, the device information transmission unit 212 acquires device information stored in the device/setting information storage unit 214, namely the serial number of the multifunction device, and transmits the serial number together with a new registration request for the device to the cloud server 100. It should be noted that the new registration request may include a product name and model information as well as a serial number.

In step S801 of FIG. 8, the device information acquisition unit 112 of the cloud server 100 acquires the device information included in the new registration request for the device, and temporarily stores the device information in the memory 102. Furthermore, the order number acquisition unit 113 acquires the order number included in the new registration request for the device, and temporarily stores the order number in the memory 102. In step S802, the device registration unit 115 determines whether or not the device that issued the new registration request is a multifunction device, on the basis of the device information acquired in step S801. If it is determined that the device is not a multifunction device, processing proceeds to step S807, and the controller 114 transmits the device registration failure to the multifunction device 200 that issued the new registration request.

In step S802, if it is determined that the device that issued the new registration request is a multifunction device, processing proceeds to step S803, and the device registration unit 115 determines whether or not the device and the registration target device are the same. It should be noted that, in order to carry out the processing of step S803, it is necessary for the registration target device, namely product information such as the product name and model information of the device, and the order number to have been associated in advance at the point in time at which the order number is issued. If the order number and the product information are not associated, the processing of step S803 may be omitted.

In step S803, if it is determined that the device and is not the registration target device, processing proceeds to step S807, and the controller 114 transmits the device registration failure to the multifunction device 200 that issued the new registration request.

In step S803, if it is determined that the device that issued the new registration request is the registration target device, processing proceeds to step S804, and the device registration unit 115 refers to the registration/setting information storage unit 116 and determines whether or not the device is unregistered. If it is determined that the device has already been registered, processing proceeds to step S807, and the controller 114 transmits the device registration failure to the multifunction device 200 that issued the new registration request.

In step S804, if it is determined that the device that issued the new registration request is unregistered, processing proceeds to step S805. In step S805, the device registration unit 115 registers the device by associating and storing, in the registration/setting information storage unit 116, the device information acquired by the device information acquisition unit 112 and the order number acquired by the order number acquisition unit 113. It should be noted that, in a case where group information specifying a group made up of multiple users who use the multifunction device 200, namely tenant information, is associated in advance with the order number, the device registration unit 115 may associate the device information with the tenant information to thereby associate the device information and the order number.

In step S806, the controller 114 transmits the registration success to the multifunction device 200 that issued the new registration request, and the registration processing in the cloud server 100 ends. In step S504 of FIG. 5, the controller 211 of the multifunction device 200 receives notification of the success of the new registration of the device, and displays an indication thereof on the user interface device 205, and processing ends. At such time, the state is as depicted in FIG. 7C with a registration success screen 704 being displayed on the user interface device 205. When the customer engineer presses the “Close” button, the screen disappears and the registration processing ends.

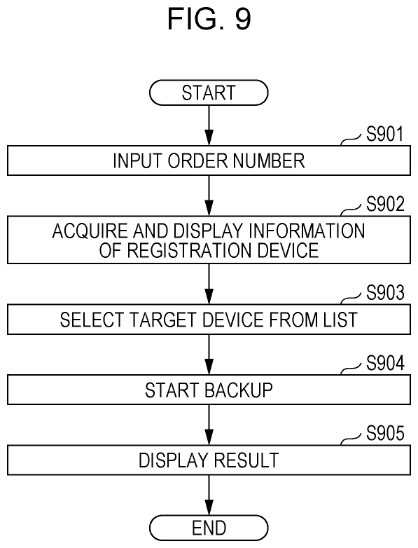

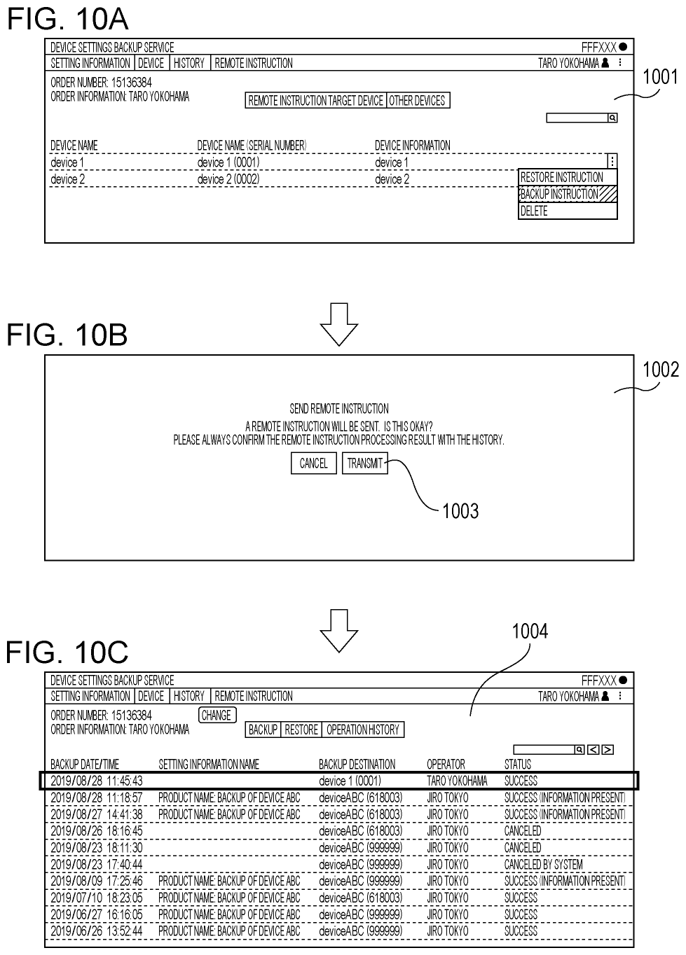

Next, the flow of processing for the customer engineer to back up setting information of the multifunction device 200A from the remote operation terminal 300 will be described with reference to FIGS. 9 and 10. It should be noted that the basic processing is the same in the case where the setting information of the old-model multifunction device 200A is backed up and the case where the setting information of the new-model multifunction device 200B is backed up, and will therefore be described as backup processing for the multifunction device 200 in the description given hereinafter. It should be noted that FIG. 9 is a flowchart depicting the flow of processing to back up setting information of the multifunction device 200. FIGS. 10A to 10C are an example of a series of user interfaces displayed on the display device of the remote operation terminal 300 when the backup processing of FIG. 9 is carried out.

It should be noted that, in the present exemplary embodiment, images displayed on the display device of the remote operation terminal 300 are provided as a web user interface generated by the controller 114 of the cloud server 100, and the remote operation terminal 300 is merely used simply as a user interface so to speak for the cloud server 100.

In step S901, the customer engineer operates the input device of the remote operation terminal 300 and inputs an order number associated with this backup/restoration processing.

In step S902, the backup/restoration remote execution unit 111 of the cloud server 100 acquires, from the registration/setting information storage unit 116, the information of multifunction devices 200 associated with the order number that has been input from the remote operation terminal 300, and displays a list on the display device of the remote operation terminal 300. FIG. 10A is a registered device list screen 1001 of registered devices to be backed up. Only multifunction devices registered in association with the order number that has been input by the customer engineer are displayed on the registered device list screen 1001. Consequently, other multifunction devices for which there is no intention to carry out backup processing are not displayed in this list.

In step S903 of FIG. 9A, the customer engineer selects the multifunction device 200 for which a backup is to be executed, from within the registered device list screen 1001 of FIG. 10A. Thereupon, the controller 114 of the cloud server 100 generates a backup execution confirmation screen 1002 such as that depicted in FIG. 10B, and causes the display device of the remote operation terminal 300 to display the backup execution confirmation screen 1002. When the customer engineer selects a transmission button 1003, processing proceeds to step S904.

In step S904, the backup/restoration remote execution unit 111 of the cloud server 100 transmits a backup processing request to the selected multifunction device 200. When the selected multifunction device 200 receives the backup processing request from the cloud server 100, the setting information transmission unit 213 acquires setting information of the multifunction device 200 saved in the device/setting information storage unit 214 and transmits the setting information to the cloud server 100. The device information acquisition unit 112 of the cloud server 100, upon receiving the setting information of the multifunction device 200, stores the setting information in the registration/setting information storage unit 116.

In step S905, when the backup/restoration remote execution unit 111 finishes receiving the setting information of the selected multifunction device 200, the controller 114 generates a backup result list screen 1004 that is displayed on the display device of the remote operation terminal 300, and processing ends.

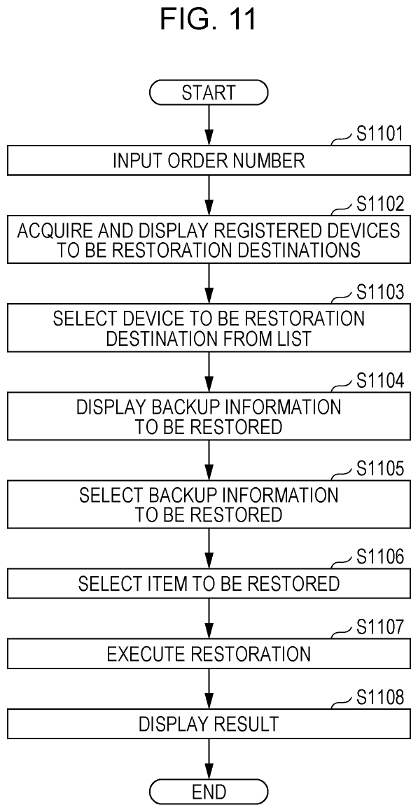

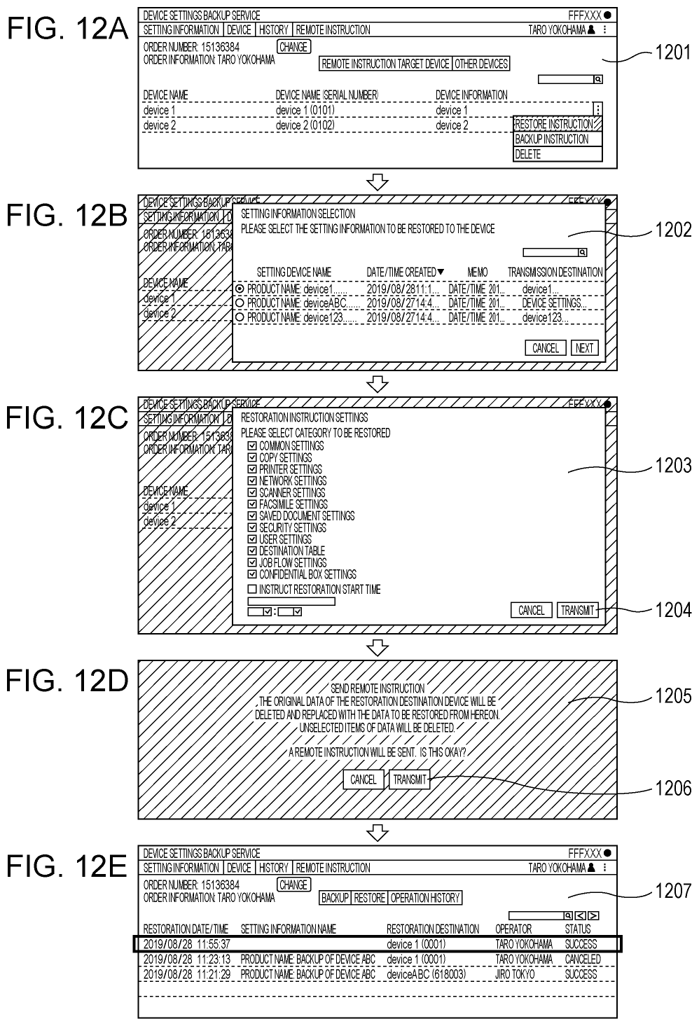

Next, the flow of processing for the customer engineer to restore setting information backed up to the cloud server 100, to the multifunction device 200B from the remote operation terminal 300 will be described with reference to FIGS. 11 and 12. It should be noted that the basic processing is the same in the case where the setting information of the old-model multifunction device 200A is restored and the case where the setting information of the new-model multifunction device 200B is restored, and will therefore be described as restoration processing for the multifunction device 200 in the description given hereinafter. It should be noted that FIG. 11 is a flowchart depicting the flow of processing to restore setting information to the multifunction device 200 from the cloud server 100. Furthermore, FIGS. 12A to 12E are an example of a series of user interfaces displayed on the display device of the remote operation terminal 300 when the restoration processing of FIG. 11 is carried out.

In step S1101, the customer engineer operates the remote operation terminal 300 and inputs an order number associated with this backup/restoration processing.

In step S1102, the backup/restoration remote execution unit 111 of the cloud server 100 acquires, from the registration/setting information storage unit 116, the information of multifunction devices 200 associated with the order number that has been input from the remote operation terminal 300, and displays a list on the display device of the remote operation terminal 300. FIG. 12A is a registered device list screen 1201 of registered devices to be restoration destinations. Similar to when the aforementioned backup processing is carried out, only multifunction devices registered in association with the order number that has been input by the customer engineer are displayed on the registered device list screen 1201. Consequently, other multifunction devices for which there is no intention to carry out restoration processing are not displayed in this list.

In step S1103 of FIG. 11, the customer engineer selects the multifunction device 200 to be a restoration destination, from within the registered device list screen 1201 of FIG. 12A. Thereupon, in step S1104, the controller 114 of the cloud server 100 acquires, from the registration/setting information storage unit 116, a list of setting information already backed up in association with the order number that has been input, and displays a list on the user interface device of the remote operation terminal 300. FIG. 12B is a setting information list screen 1202 of setting information already backed up to the cloud server 100. For example, FIG. 12B includes three items of setting information already backed up in association with the order number.

In step S1105, the customer engineer selects one item of setting information of the setting information list screen 1202 of FIG. 12B, and thereupon, in step S1106, the controller 114 of the cloud server 100 generates a restoration target selection screen 1203 such as that of FIG. 12C, which allows the selection of setting items that can be restored from among the setting information selected in step S1104, from the registration/setting information storage unit 116, and causes the display device of the remote operation terminal 300 to display the restoration target selection screen 1203.

The setting items that can be restored, displayed on the restoration target selection screen 1203, include function settings such common settings, printer settings, and so forth.

When the customer engineer selects a desired setting item from among the setting items displayed on the restoration target selection screen 1203 and selects a transmission button 1204, the controller 114 of the cloud server 100 generates a restoration execution confirmation screen 1205 such as that of FIG. 12D, and causes the display device of the remote operation terminal 300 to display the restoration execution confirmation screen 1205. When the customer engineer selects a transmission button 1206, processing proceeds to step S1107.

In step S1107, the backup/restoration remote execution unit 111 of the cloud server 100 acquires, from the registration/setting information storage unit 116, backup information to be a restoration target selected in steps S1105 and S1106, and transmits the backup information together with a restoration processing request to the multifunction device 200 selected as a restoration destination in step S1103.

The controller 211 of the multifunction device 200, upon receiving the restoration processing request from the cloud server 100, saves setting information received together with the restoration processing request in the device/setting information storage unit 214, overwrites setting information, and notifies the cloud server 100 that the restoration processing is complete.

When the backup/restoration remote execution unit 111 of the cloud server 100 finishes transmitting the setting information to the multifunction device 200 and receives notification of the completion of the restoration processing from the multifunction device 200, in step S1108, the controller 114 generates a restoration result list screen 1207 that is displayed on the display device of the remote operation terminal 300, and processing ends.

It should be noted that, in the exemplary embodiment above, the term “processor” refers to hardware in a broad sense. Examples of a processor include general processors (e.g., CPUs: central processing units) and dedicated processors (e.g., GPUs: graphics processing units, ASICs: application integrated circuits, FPGAs: field programmable gate arrays, and programmable logic devices).

In the exemplary embodiment above, the term “processor” is broad enough to encompass one processor or plural processors in collaboration which are located physically apart from each other but may work cooperatively. Furthermore, the order of operations of the processor is not limited to one described in the exemplary embodiment above, and may be changed.

In the aforementioned exemplary embodiment, an example has been described in which the device registration unit 115 of the cloud server 100 is provided with a function to permit an order number and device information to be associated and registered only when an order number is input directly from the user interface device 205 of the multifunction device 200, and the device information transmission unit 212 of the multifunction device 200 is also provided with a function to prohibit transmission processing for device information apart from when an order number is input directly from the user interface device 205 of the multifunction device 200. However, it should be noted that the present disclosure may be implemented in such a way that the aforementioned functions are provided in either one of the cloud server 100 and the multifunction device 200. Furthermore, the remote operation terminal 300 may be provided with a function to determine whether or not an order number is input directly from the user interface device 205 of the multifunction device 200, and associating and registering an order number and device information may be permitted only when it is determined that an order number is input directly from the user interface device 205 of the multifunction device 200.

Furthermore, in the aforementioned exemplary embodiment, a case has been described where a customer engineer carries out backup processing or restoration processing for setting information of the multifunction device 200 by way of a remote operation. However, a configuration may be adopted in which the input of an order number is not requested in a case where, rather than a customer engineer, an administrator or the like who ordinarily operates the multifunction device 200 at the installation site logs in to the multifunction device 200 and directly operates the user interface device 205 of the multifunction device 200 to thereby carry out backup processing or restoration processing with respect to the cloud server 100.

Furthermore, in the aforementioned exemplary embodiment, a case has been described where restoration processing is immediately carried out at the point in time at which the customer engineer instructs restoration processing to be executed. However, the present disclosure is not restricted thereto, and the time at which restoration processing is actually carried out may be designated. In this case, at the point in time at which execution of restoration processing is instructed from the customer engineer, setting information is transmitted from the cloud server 100 to the multifunction device 200 and temporarily stored in the storage device 203 of the multifunction device. Thereafter, at the stage when the designated time is reached, the controller 211 overwrites setting information of the device/setting information storage unit 214 with the setting information temporarily stored in the storage device 203, and restoration of the setting information ends.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing device connected to an image forming device via a network, and comprising a processor configured to,
in a case where backup processing or restoration processing for setting information of the image forming device is executed by way of a remote operation, associate and register device information that uniquely specifies the image forming device, and identification information for a remote operation service in which the backup processing or the restoration processing is executed by way of the remote operation, in a case where the device information and the identification information are acquired from the image forming device without the image forming device being operated remotely, prior to the backup processing or the restoration processing.

2. The information processing device according to claim 1,
wherein the processor prohibits the device information and the identification information from being acquired from the image forming device and associated by way of a remote operation.

3. The information processing device according to claim 1,
wherein the processor permits the device information and the identification information being acquired from the image forming device, in a case where the device information and the identification information are transmitted by the image forming device being operated directly.

4. The information processing device according to claim 1,
wherein processing to carry out the registering is processing in which the device information and the identification information are associated by associating the device information that uniquely specifies the image forming device with group information that specifies a group made up of a plurality of users who use the image forming device and to whom the remote operation is provided.

5. The information processing device according to claim 2,
wherein processing to carry out the registering is processing in which the device information and the identification information are associated by associating the device information that uniquely specifies the image forming device with group information that specifies a group made up of a plurality of users who use the image forming device and to whom the remote operation is provided.

6. The information processing device according to claim 3,
wherein processing to carry out the registering is processing in which the device information and the identification information are associated by associating the device information that uniquely specifies the image forming device with group information that specifies a group made up of a plurality of users who use the image forming device and to whom the remote operation is provided.

7. An image forming device comprising a processor configured such that,
in a case where backup processing or restoration processing for setting information of the image forming device is executed by receiving a remote operation,
device information that uniquely specifies the image forming device is not transmitted by way of a remote operation, prior to the backup processing or the restoration processing.

8. The image forming device according to claim 7,
wherein the image forming device further comprises an input device,
and the processor permits transmission processing for the device information, only when identification information for a remote operation service in which the backup processing or the restoration processing is executed by way of a remote operation is input directly from the input device.

9. The image forming device according to claim 7,
wherein the processor prohibits transmission processing for the device information, apart from when identification information for a remote operation service in which the backup processing or the restoration processing is executed by way of a remote operation is input directly from an input device.

10. An information processing system comprising an information processing device and an image forming device connected to each other via a network,
wherein, in a case where the image forming device executes backup processing or restoration processing for setting information of the image forming device by receiving a remote operation,
the image forming device transmits device information that uniquely specifies the image forming device, and identification information for a remote operation service in which the backup processing or the restoration processing is executed by way of a remote operation, to the information processing device, only in a case where the image forming device is operated directly, prior to the backup processing or the restoration processing,
and the information processing device registers the device information and the identification information acquired from the image forming device, in association with each other.

11. An information processing system comprising an information processing device and a remote operation terminal each connected to an image forming device via a network,
wherein the information processing device registers device information and identification information in association with each other, in a case where the device information and the identification information are acquired from the image forming device without the image forming device being operated remotely, prior to the remote operation terminal executing the backup processing or the restoration processing for setting information of the image forming device by way of a remote operation, the device information specifying the image forming device, the identification information being information for a remote operation service in which the backup processing or restoration processing is executed by way of a remote operation,
and the remote operation terminal executes the backup processing or the restoration processing by remotely operating the image forming device using the identification information, in a case where the device information and the identification information are registered in the information processing device in association with each other.
